(19) United States
(12) Patent Application Publication
(10) Pub. No.: US 2015/0353114 A1
(43) Pub. Date: Dec. 10, 2015

(54) Shopping Cart Bumper

(71) Applicant: Technibilt, Ltd., Newton, NC (US)

(72) Inventors: Francois Morin, Montreal (CA); Gennaro Rosato, Montreal (CA); Will Kiser, Lincolnton, NC (US)

(21) Appl. No.: 14/730,560

(22) Filed: Jun. 4, 2015

Related U.S. Application Data
(60) Provisional application No. 62/007,519, filed on Jun. 4, 2014.

(51) Int. Cl. B62B 5/00; B62B 3/14

(52) U.S. Cl. CPC B62B 5/0006; B62B 3/1412

(57) ABSTRACT

A bumper for use in combination with a shopping cart includes a first faceplate extending from a second faceplate at an angle between 80 degrees and 120 degrees, and each of the first and second faceplates having a front surface and a rear surface; an elongated recessed face on the front surface of each of the first and second faceplates; an elongated strip of tape having a first surface that is reflective and a second surface that is adhesive, and wherein the second surface of the elongated strip of tape is sized and configured for adhered receipt on each of the first and second elongated recessed faces; and a plurality of mounting flanges each being secured to the rear surfaces of the first and second faceplates, and wherein each of the plurality of mounting flanges is selectively securable to the shopping cart for supporting the first and second faceplates thereon.

### RELATED APPLICATION

This application is a Non-provisional Patent Application relating to and claiming the benefit of U.S. Provisional Patent Application Ser. No. 62/007,519 filed on Jun. 4, 2014.

### FIELD OF THE INVENTION

This invention relates to shopping carts and, more particularly, to an improved shopping cart bumper.

### BACKGROUND OF THE INVENTION

Shopping carts having baskets made from welded wires are in widespread use throughout the world. In order to reduce damage to store fixtures, automobiles in store parking lots, and to other objects which may be accidentally struck by the shopping cart, bumpers are often attached to the front corners of the upper basket of the shopping cart. Normally, the bumpers are made of a resilient material. An example of such a bumper is disclosed in U.S. Pat. No. 5,131,699 issued to Kinnamon.

Large retail stores, such as grocery stores, often have large parking lots adjacent to the store. In many instances, customers are encouraged to use a shopping cart to transport goods purchased in the store to their vehicles located in the parking lot. Often shopping cart corrals are provided in the parking lot so that customers can place their empty carts therein after the goods have been unloaded from the carts into their vehicles. However, it has been found that in many instances, the shopper does not place the cart in the cart corral but simply leaves it in the parking lot near where his or her vehicle was parked. When this occurs at night, it has been found that other vehicles entering the parking lot will strike the shopping cart with their vehicle, causing damage to both the shopping cart and to the vehicle because shopping carts can be difficult to see at night.

### SUMMARY OF THE INVENTION

In accordance with one form of the present invention, there is provided a bumper for use in combination with a shopping cart, and the bumper including a first faceplate and a second faceplate, the first faceplate extending from the second faceplate at an angle between 80 degrees and 120 degrees, and each of the first and second faceplates having a front surface and a rear surface; an elongated recessed face on the front surface of each of the first and second faceplates; an elongated strip of tape having a first surface that is reflective and a second surface that is adhesive, and wherein the second surface of the elongated strip of tape is sized and configured for adhered receipt on each of the first and second elongated recessed faces; and a plurality of mounting flanges each being secured to the rear surfaces of the first and second faceplates, and wherein each of the plurality of mounting flanges is selectively securable to the shopping cart for supporting the first and second faceplates thereon.

In accordance with another form of the present invention, there is provided a shopping cart having a front and a rear end, the shopping cart including a basket structure and at least one wheel secured thereto for selective transportation of the basket structure by a user; and at least one bumper, and the at least one bumper including a first faceplate and a second faceplate, the first faceplate extending from the second faceplate at an angle between 80 degrees and 120 degrees, and each of the first and second faceplates having a front surface and a rear surface; an elongated recessed face on the front surface of each of the first and second faceplates: an elongated strip of tape having a first surface that is reflective and a second surface that is adhesive, and wherein the second surface of the elongated strip of tape is sized and configured for adhered receipt on each of the first and second elongated recessed faces; and a plurality of mounting flanges each being secured to the rear surfaces of the first and second faceplates, and wherein each of the plurality of mounting flanges is selectively securable to the shopping cart for supporting the first and second faceplates thereon.

### BRIEF DESCRIPTION OF THE DRAWINGS

For a fuller understanding of the nature of the present invention, reference should be made to the following detailed description, taken in conjunction with the accompanying drawings in which:

FIG. 1 is a perspective view showing the front side of one embodiment of the shopping cart bumper of the present invention;

FIG. 2 is a front elevational view of the embodiment of FIG. 1;

FIG. 3 is a rear perspective view of the embodiment of FIG. 1;

FIG. 4 is a rear elevational view of the embodiment of FIG. 1;

FIG. 5 is a top view of the embodiment of FIG. 1;

FIG. 6 is a perspective view of the embodiment of FIG. 1 with reflective tape being applied to the bumper;

FIG. 7 is a perspective view of the embodiment of FIG. 1 installed on opposite corners of a shopping cart;

FIG. 8 is a top view of one corner of the shopping cart FIG. 7 illustrating the shopping cart bumper of the present invention; and

FIG. 9 is a side view of a rod which may be used to fasten the shopping cart bumper of the present invention to the shopping cart.

Like reference numerals refer to like parts throughout the several views of the drawings.

### DETAILED DESCRIPTION OF THE PREFERRED EMBODIMENTS

Referring to the several views of the drawings, the shopping cart bumper of the present invention is shown and is generally indicated as 10.

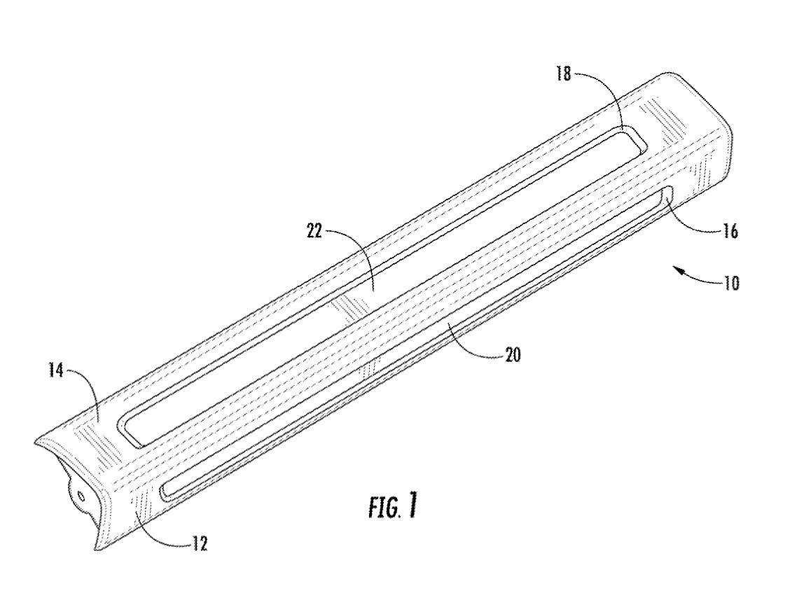

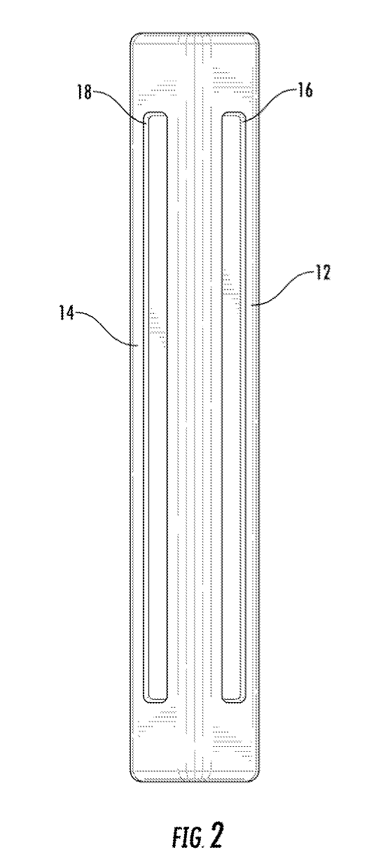

Referring to FIGS. 1 and 2, bumper 10 includes front faces 12 and 14 which are at an angle with respect to one another. Front faces 12 and 14 may also be referred to as first and second faceplates 12 and 14 throughout. Preferably, the angle is between eighty degrees and one hundred twenty degrees, and more preferably, the angle is ninety-five degrees. Bumper 10 is molded from a resilient plastic material, preferably high density polyethylene. Face 12 includes elongated recessed face or groove 16 and face 14 includes elongated recessed face or groove 18. Grooves 16 and 18 receive reflective tape 20 and 22, respectively. Tape 20 and 22 is formed into the shape of the groove but slightly smaller. Since both grooves 16 and 18 and tapes 20 and 22 are identical in a preferred embodiment of the invention, only one groove and one tape will be described in more detail. Preferably, the bottom of groove 16 is between 1/32 inch and 3/32 inch below the surface of face 12. More preferably, the bottom of groove 16 is 1/16 inch below the surface of face 12.

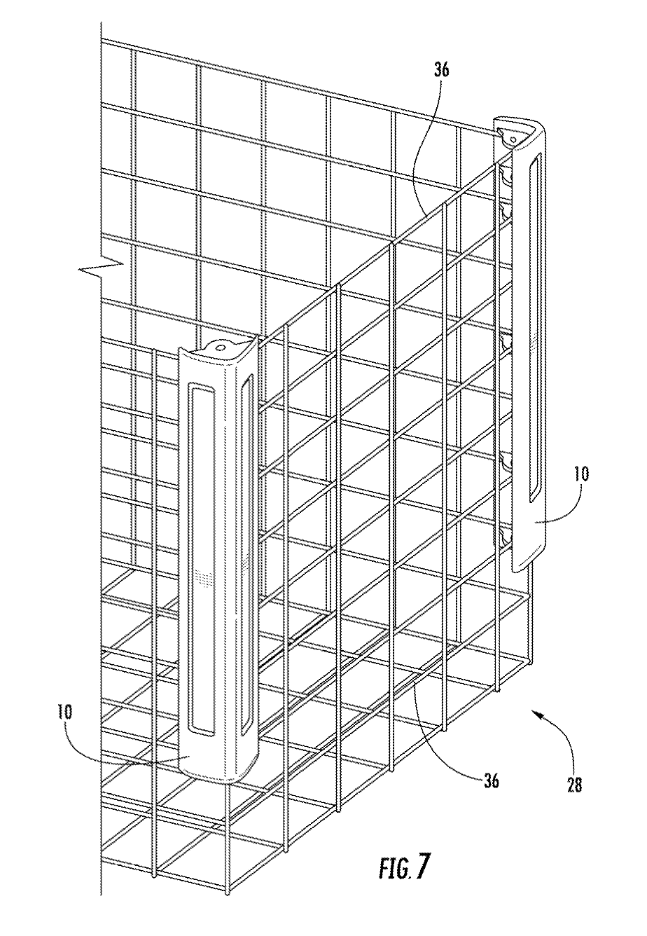

Tape 20, 22 includes reflective side 24 and adhesive side 26. Reflective side 24 is made of a material which will reflect light, such as light from a vehicle headlight. Adhesive side 26 is a pressure sensitive adhesive. It can be seen in FIG. 7 that each bumper 10 is mounted on one front corner of shopping cart 28. There will also be another identical bumper 10 mounted on the opposite front corner of shopping cart 28. While the embodiment of the shopping cart bumper 10 has thus far been shown and described as being securable to the front corners of the shopping cart 28, it is considered that the bumper 10 may be secured to the shopping cart 28 at alternative locations, such as the rear corners of the shopping cart. Moreover, each face 12, 14 may include a plurality of grooves 16, 18 and a corresponding plurality of tapes 20, 22.

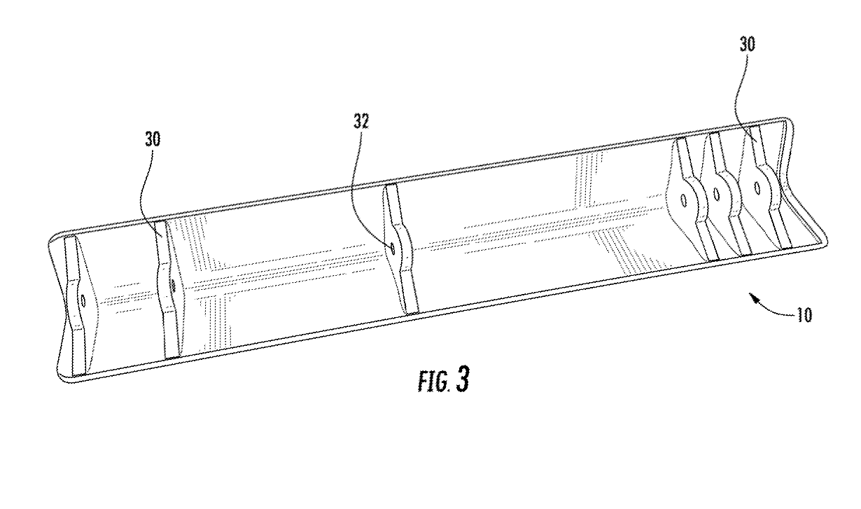

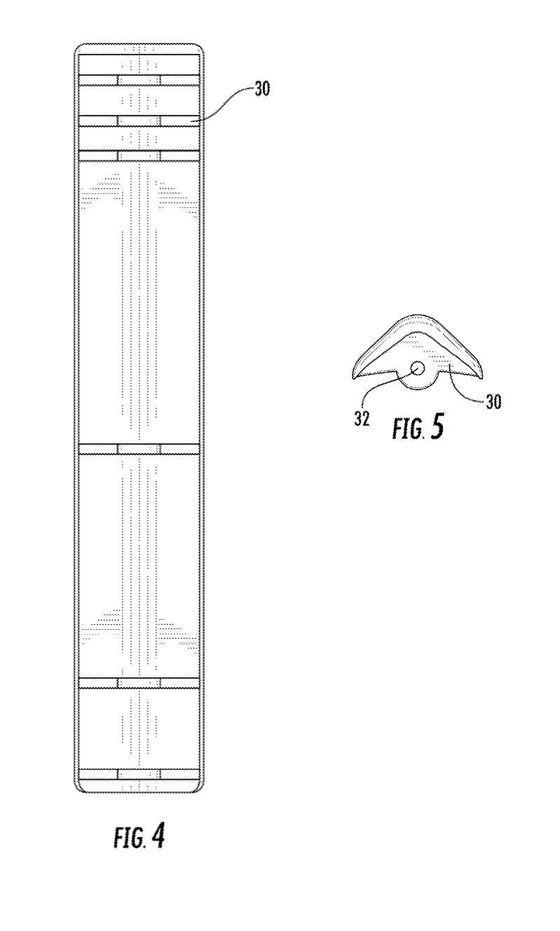

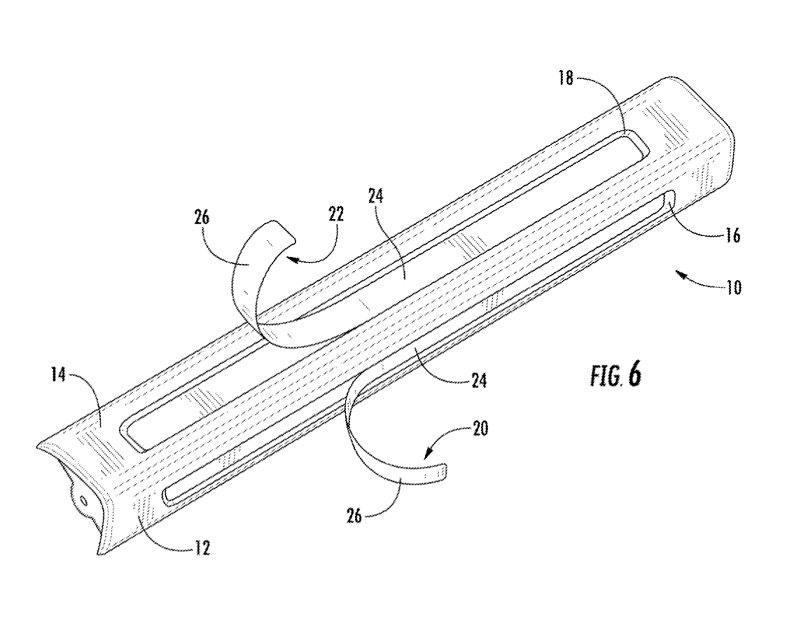

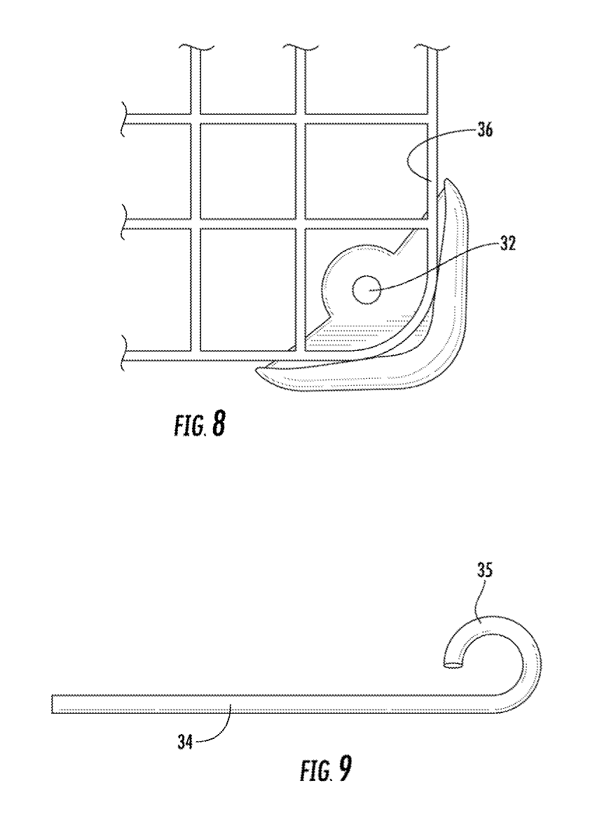

As can be seen from FIGS. 3 and 4, bumper 10 includes a plurality of mounting flanges 30. The mounting flanges 30 each include an aperture or hole 32 extending therethrough. The holes 32 of the mounting flanges 30 are aligned, i.e. vertical alignment, as shown in FIG. 5. After the bumper 10 is placed against the front corner of the shopping cart, as shown in FIG. 8, a rod 34 (see FIG. 9) is passed through the holes 32 in the mounting flanges 30. Rod 34 braces against wires 36 on the interior portion of the corner of the shopping cart to secure the bumper 10 in place.

Since the reflective tape 20, 22 is visible from the front and sides of the shopping cart, the driver of a motor vehicle at night in the store parking lot will be likely to see the shopping cart and thus, avoid a collision. In addition, since the reflective tape 20, 22 is recessed in the grooves 16 and 18 in the bumper, the likelihood that the tape would be damaged if and when the bumper comes in contact with other objects such as store fixtures is reduced.

From the foregoing description of one embodiment of the invention, it will be apparent that many modifications may be made therein. It will be understood that this embodiment of the invention is an exemplification of the invention only and that the invention is not limited thereto. For example, horizontal grooves 16 and 18 containing reflective tape 20, 22 in the bumpers could be used in lieu of vertical grooves. In addition, three or more bumpers could be used on the shopping cart. Additionally, more than one groove containing reflective tape may be included on the faces 12 and 14 of each bumper 10.

While the present invention has been shown and described in accordance with several preferred and practical embodiments, it is recognized that departures from the instant disclosure are contemplated within the spirit and scope of the present invention which are not limited except as defined in the following claims as interpreted by the Doctrine of Equivalents.

What is claimed is:

1. A bumper for use in combination with a shopping cart, and said bumper comprising:
a first faceplate and a second faceplate, said first faceplate extending from said second faceplate at an angle between 80 degrees and 120 degrees, and each of said first and second faceplates having a front surface and a rear surface;
an elongated recessed face n the front surface of each of said first and second faceplates;
an elongated strip of tape having a first surface that is reflective and a second surface that is adhesive, and wherein the second surface of said elongated strip of tape is sized and configured for adhered receipt on each of said first and second elongated recessed faces; and
a plurality of mounting flanges each being secured to the rear surfaces of said first and second faceplates, and wherein each of said plurality of mounting flanges is selectively securable to the shopping cart for supporting said first and second faceplates thereon.

2. The bumper as recited in claim 1 wherein each of said mounting flanges includes an aperture extending therethrough, and wherein each of the apertures on each of said plurality of mounting flanges are in alignment.

3. The bumper as recited in claim 2 further comprising a rod that is sized and configured for passage through each of the apertures on each of said plurality of mounting flanges for securing said bumper to the shopping cart.

4. The bumper as recited in claim 1 wherein said first faceplate extends from said second faceplate at a 95 degree angle.

5. The bumper as recited in claim 1 wherein said first and second faceplates and said plurality of mounting flanges are made from high density polyethylene.

6. The bumper as recited in claim 1 wherein said elongated recessed face is between 1/32 inch and 3/32 inches below the front surface of each of said first and second faceplates.

7. A shopping cart having a front and a rear end, said shopping cart comprising:
a basket structure and at least one wheel secured thereto for selective transportation of said basket structure by a user; and
at least one bumper, and said at least one bumper comprising:
a first faceplate and a second faceplate, said first faceplate extending from said second faceplate at an angle between 80 degrees and 120 degrees, and each of said first and second faceplates having a front surface and a rear surface;
an elongated recessed face on the front surface of each of said first and second faceplates;
an elongated strip of tape having a first surface that is reflective and a second surface that is adhesive, and wherein the second surface of said elongated strip of tape is sized and configured for adhered receipt on each of said first and second elongated recessed faces; and
a plurality of mounting flanges each being secured to the rear surfaces of said first and second faceplates, and wherein each of said plurality of mounting flanges is selectively securable to the shopping cart for supporting said first and second faceplates thereon.

8. The shopping cart as recited in claim 7 wherein said basket structure includes four sidewalls extending upwards from a bottom surface forming a perimeter surface of said basket structure having four corners.

9. The shopping cart as recited in claim 8 wherein said at least one bumper is a first bumper and a second bumper each being secured to opposing corners of said basket structure at the front end of the shopping cart.

10. The shopping cart as recited in claim 8 wherein said at least one bumper is a first, second, third and fourth bumper each being secured to a respective one of said four corners of said basket structure of the shopping cart.

11. The shopping cart as recited in claim 7 wherein each of said mounting flanges includes an aperture extending therethrough, and wherein each of the apertures on each of said plurality of mounting flanges are in alignment.

12. The shopping cart as recited in claim 11 further comprising a rod that is sized and configured for passage through each of the apertures on each of said plurality of mounting flanges for securing said bumper to the shopping cart.

13. The shopping cart as recited in claim 7 wherein said first faceplate extends from said second faceplate at a 95 degree angle.

14. The shopping cart as recited in claim 7 wherein said first and second faceplates and said plurality of mounting flanges are made from high density polyethylene.

15. The shopping cart as recited in claim 7 wherein said elongated recessed face is between 1/32 inch and 3/32 inches below the front surface of each of said first and second faceplates
